(19) United States
(12) Patent Application Publication
(10) Pub. No.: US 2023/0142965 A1
(43) Pub. Date: May 11, 2023

(54) FEDERATED MACHINE LEARNING BASED BROWSER EXTENSION

(71) Applicant: PayPal, Inc., San Jose, CA (US)

(72) Inventors: Vandit Khamker, Milpitas, CA (US); Arvind Srinath Shankaranarayanan, Fremont, CA (US); Rohit Bethmangalkar, San Jose, CA (US); Chenzhi Zhao, San Jose, CA (US); Hagar Oppenheim, Santa Clara, CA (US); Niranjana Nempe, San Jose, CA (US)

(21) Appl. No.: 17/522,277

(22) Filed: Nov. 9, 2021

(51) Int. Cl. G06Q 30/02; G06F 21/62; H04L 67/5683

(52) U.S. Cl. CPC G06Q 30/0244; G06F 21/6263; G06Q 30/0255; G06Q 30/0276; H04L 67/2857

(57) ABSTRACT

Computer software architectures are disclosed that use improved machine learning techniques for computer data security, data science, and data privacy protection. Computer operations are improved by more efficiently and effectively processing relevant data, such as web browsing history data. Web browsing data that are representative of web browsing history based on activity associated with a web browser application determined. Using a base model and based on the web browsing data, federated machine learning applied to past web browsing data representative of past web browsing history associated with other web browser applications other than the web browser application can be used to generate an updated targeted model.

### TECHNICAL FIELD

The disclosed subject matter generally relates to computer software architectures for data science and web browser extensions, and more particularly to federated machine-learning based improvements to web browser extensions privacy protection, according to various embodiments.

### BACKGROUND

Conventionally, a system can access web browsing history via a web browser. A conventional system can then send the web browsing history to a central server for variety of uses or data-science based analyses. However, by sending the web browsing history to a central sever, privacy associated with the system is not maintained, thus eroding user data privacy. User data is less secure (e.g. more systems, networks, and people) have access to it under such a scheme as above.

### BRIEF DESCRIPTION OF DRAWINGS

FIG. 1 is a block diagram of an exemplary system in accordance with one or more embodiments described herein.

FIG. 2 is a block diagram of an exemplary system in accordance with one or more embodiments described herein.

FIG. 3 illustrates a block diagram of exemplary federated machine learning for use with a browser extension in accordance with one or more embodiments described herein.

FIG. 4 is a flowchart of a process associated with federated machine learning based browser extensions in accordance with one or more embodiments described herein.

FIG. 5 is a flowchart of a process associated with federated machine learning based browser extensions in accordance with one or more embodiments described herein.

FIG. 6 is a block flow diagram of a process associated with federated machine learning based browser extensions in accordance with one or more embodiments described herein.

FIG. 7 is a block flow diagram of a process associated with federated machine learning based browser extensions in accordance with one or more embodiments described herein.

FIG. 8 is a block flow diagram of a process associated with federated machine learning based browser extensions in accordance with one or more embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, web browser extension privacy can be improved in various ways, and various embodiments are described herein to this end and/or other ends.

Various embodiments herein can leverage private federated machine-learning in order to generate highly accurate machine-learning based models based on, for instance, web browsing history at a web browser application. In this regard, embodiments herein can enable localized machine learning at a web browser extension and prevent the web browsing history from leaving the browser extension, thus promoting privacy associated with the web browsing history. Accuracy of models herein can be improved by utilizing federated machine learning in order to aggregate the learning from a plurality of browser extensions.

Accordingly, techniques herein can improve computer performance by providing greater accuracy of data models, leading to more effective identification and classification by machine learning engines, saving processor cycles, memory usage, and power usage. Techniques herein also improve computer security by providing greater data security to users by not transmitting potentially sensitive data to a central server, according to various embodiments. By retaining this user data, it is less likely to be potentially compromised (e.g. intercepted or accessed by an unauthorized party).

According to an embodiment, a system can comprise a processor, and a memory that stores executable instructions that, when executed by the processor, cause the system to perform operations, comprising: determining web browsing data that are representative of web browsing history based on activity associated with a web browser application, using a base targeted offer model and based on the web browsing data, generating a targeted offer, wherein the base targeted offer model has been generated based on federated machine learning applied to past web browsing data representative of past web browsing history associated with other web browser applications other than the web browser application, and based on success data representative of a level of success of the base targeted offer model, according to a success criterion, and based on the base targeted offer model, generating an updated targeted offer model.

In various embodiments, the base targeted offer model can be generated using the federated machine learning using respective machine learning operations at respective web browser applications, comprising the web browser application, without exchanging web browsing history between the web browser applications. In this regard, the base targeted offer model can generate initial targeted offers via the web browser application, based on the web browsing history. It is noted that the web browsing history can comprise past web browsing activity, accessed via the web browser application and associated with a product or service. In this regard, an initial targeted offer of the initial targeted offers can be based in part on the product or the service. Further, the federated machine learning can be employable, by the system, to generate the updated targeted offer model based on the success data. In this regard, the success data can be further representative of a conversion rate associated with the initial targeted offers.

In one or more embodiments, the above operations can further comprise: transmitting the updated targeted offer model to a server. It is noted that, in various embodiments, transmitting the updated targeted offer model does not transmit the web browsing data. In additional embodiments, the above operations can further comprise: receiving, from the server, an updated base targeted offer model. In this regard, the updated base targeted offer model can be generated using federated machine learning applied to the updated targeted offer model and other updated targeted offer models, other than the updated targeted offer model, associated with other web browser applications other than the web browser application.

In various embodiments, the web browsing history can comprise historical web browsing activity associated with one or more users of the system. In this regard, the web browsing history can be employable, by the system using the base targeted offer model or the updated targeted offer model, to generate a targeted offer for a product or service. In some embodiments, the web browsing history and the updated targeted offer model can be stored in a local data cache associated with a web browser extension of the web browser application.

In additional embodiments, the above operations can further comprise: determining battery status information representative of a battery status of user equipment associated with the web browser application. In this regard, the generating the updated targeted offer model can comprise generating the updated targeted offer model in response to the battery status information being determined to satisfy a battery status threshold.

In various embodiments, the above operations can further comprise: determining network status information representative of a network connection type and strength of user equipment associated with the web browser application. In this regard, the generating the updated targeted offer model can comprise generating the updated targeted offer model in response to the network status information being determined to satisfy a network status threshold.

In another embodiment, a computer-implemented method can comprise: sending, by a system comprising a processor to a web browser extension, a base targeted offer model, wherein the base targeted offer model has been generated based on federated machine learning applied to past web browsing data representative of past web browsing history associated with other web browser extensions other than the web browser extension, receiving, by the system from the web browser extension, an updated targeted offer model, wherein the updated targeted offer model is generated by the web browser extension based on success data representative of a level of success of the base targeted offer model according to a success criterion, and based on the base targeted offer model, and aggregating, by the system and using the federated machine learning, the updated targeted offer model with other updated targeted offer models, other than the updated targeted offer model, associated with other web browser extensions other than the web browser extension, resulting in an aggregated base targeted offer model.

In various embodiments, the method can further comprise: sending, by the system, the aggregated base targeted offer model to the web browser extension and to the other web browser extensions.

In one or more embodiments, the method can further comprise: determining, by the system, battery status information representative of a battery status of user equipment associated with the web browser extension. In this regard, the sending the aggregated base targeted offer model to the web browser extension can comprise sending the aggregated base targeted offer model to the web browser extension in response to the battery status information being determined to satisfy a battery status threshold.

In some embodiments, the method can further comprise: determining, by the system, network status information representative of a network connection type and strength of user equipment associated with the web browser extension. In this regard, the sending the aggregated base targeted offer model to the web browser extension can comprise sending the aggregated base targeted offer model to the web browser extension in response to the network status information being determined to satisfy a network status threshold.

It is noted that, in various embodiments, the updated targeted offer model does not include web browsing history associated with the web browser extension.

In one or more embodiments, the method can further comprise: sending, by the system to the web browser extension, offer data representative of available offers. In this regard, the web browser extension can generate a targeted offer from among the available offers based on web browsing history associated with the web browser extension and the base targeted offer model.

In yet another embodiment, a non-transitory machine-readable medium can comprise executable instructions that, when executed by a processor, facilitate performance of operations, comprising: using a base targeted offer model and web browsing data, representative of web browsing history based on activity associated with a web browser extension, generating a targeted offer, wherein the base targeted offer model has been generated based on federated machine learning applied to past web browsing data that are representative of past web browsing history associated with other web browser extensions other than the web browser extension, based on success data representative of a level of success of the base targeted offer model, according to a success criterion, and based on the base targeted offer model, generating an updated targeted offer model, and transmitting the updated targeted offer model to an external server, wherein the transmitting the updated targeted offer model does not transmit the web browsing data.

In various embodiments, the above operations can further comprise: receiving, from the external server, an updated base targeted offer model. In this regard, the updated base targeted offer model can be generated using federated machine learning applied to the updated targeted offer model and other updated targeted offer models, other than the updated targeted offer model, associated with other web browser extensions other than the web browser extension.

In one or more embodiments, the above operations can further comprise: accessing, from the external server, offer data representative of available offers. In this regard, the targeted offer can be from among the available offers.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

It should be appreciated that additional manifestations, configurations, implementations, protocols, etc. can be utilized in connection with the following components described herein or different/additional components as would be appreciated by one skilled in the art.

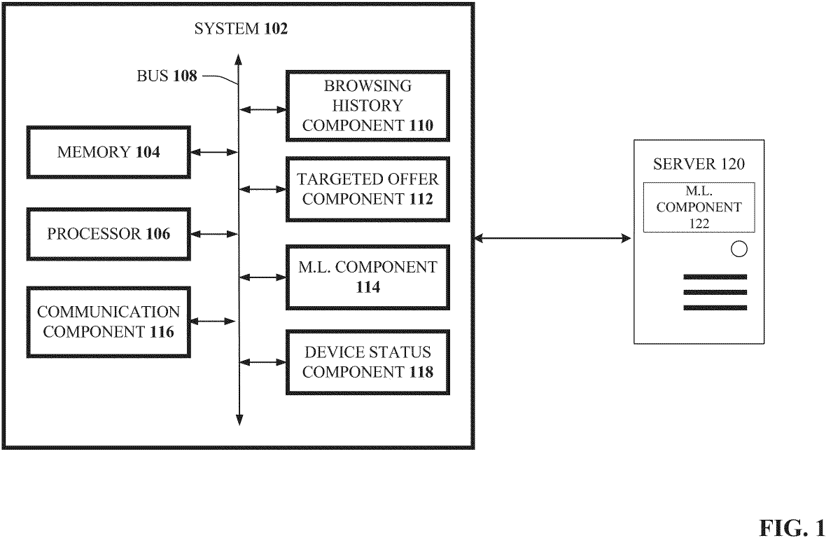

Turning now to FIG. 1, there is illustrated an example, non-limiting system 102 in accordance with one or more embodiments herein. System 102 can comprise a computerized tool (e.g., any suitable combination of computer-executable hardware and/or computer-executable software) which can be configured to perform various operations relating to federated machine learning and/or web browser extensions. The system 102 can comprise one or more of a variety of components, such as memory 104, processor 106, bus 108, browsing history component 110, targeted offer component 112, machine learning (M.L.) component 114, communication component 116, and/or device status component 118. In various embodiments, the system 102 can be communicatively coupled to a server 120.

In various embodiments, one or more of the memory 104, processor 106, bus 108, browsing history component 110, targeted offer component 112, M.L. component 114, communication component 116, and/or device status component 118 can be communicatively or operably coupled (e.g., over a bus or wireless network) to one another to perform one or more functions of the system 102.

According to an embodiment, the browsing history component 110 can determine web browsing data that are representative of web browsing history based on activity associated with a web browser application. In some embodiments, such web browser history can be recorded by the browsing history component 110. In other embodiments, such web browsing history can be accessed (e.g., by the browsing history component 110) from an associated web browser application. Such web browsing history can be utilized in order to determine shopping preferences, interests, activities, hobbies, professions, habits, demographics, or other information that can be utilized by various embodiments herein in order to generate targeted offers (e.g., a discounts for a products or services) an entity or user associated with the web browsing history would be likely (e.g., threshold likely) to complete, thus fostering a purchase of the product or service. In various embodiments, web browsing history herein can comprise historical web browsing activity associated with one or more users of the system (e.g., system 102). In this regard, the web browsing history can be employable, by the system (e.g., using a targeted offer component 112 of the system 102) using the base targeted offer model or the updated targeted offer model, to generate a targeted offer for a product or service.

According to an embodiment, the targeted offer component 112 can, using a base targeted offer model and based on the web browsing data, generate a targeted offer. The targeted offer can comprise a discount, promotion, invitation, or another offer that an entity (e.g., a user) associated with the web browsing history would be threshold likely to accept or complete. In various embodiments, the base targeted offer model can be generated based on federated machine learning (e.g., private federated machine learning) (e.g., using an M.L. component 114 or an M.L. component 122 or server 120) applied to past web browsing data representative of past web browsing history associated with other web browser applications other than the web browser application. In this regard, past web browsing data (e.g., of other entities or users) can be utilized in order to generate the base targeted offer model. Further in this regard, the base targeted model can be served from within the browser extension in order to generate targeted offers based on browsing behavior (e.g., browsing history) using the base targeted offer model. According to an example, web browsing data herein can indicate that a web browser navigated to a “website A” associated with “store A” and “website B” associated with “store B.” Such web browsing data can be utilized by the base targeted offer model (and/or other models herein) in order to determine targeted offers (e.g., from available targeted offers) that a user would be likely to utilize to complete a purchase or transaction. Such a purchase or transaction can comprise a successful conversion of a targeted offer.

According to an embodiment, the M.L. component 114 can, based on success data representative of a level of success of the base targeted offer model, according to a success criterion (e.g., a defined offer conversion rate), and based on the base targeted offer model, generate an updated targeted offer model. It is noted that the foregoing can comprise model training which can be utilized in order to improve accuracies models herein and/or conversion rates of targeted offers herein. In various embodiments, model training and/or federated learning herein can be facilitated (e.g., using a system 102 or another system herein) at a web browser extension (e.g., embedded within a web browser extension). In this regard, the M.L. component 114 can (e.g., locally at the system 102) utilize local success and failure data representative of conversions (e.g., conversion rate(s)) of the targeted offer(s) herein in order to train the model locally stored on the system 102 (e.g., stored in the memory 104).

It is noted that the base targeted offer model can be generated using the federated machine learning (e.g., one or more of an M.L. component 114) using respective machine learning operations at respective web browser applications, comprising the web browser application, without exchanging web browsing history between the web browser applications. In this regard, the base targeted offer model can generate initial targeted offers via the web browser application, based on the web browsing history. It is further noted that the web browsing history can comprise past web browsing activity accessed via the web browser application and associated with a product or service. In this regard, an initial targeted offer of the initial targeted offers can be based in part on the product or the service. In an embodiment, the federated machine learning can be employable (e.g., using the M.L. component 114) in order to generate the updated targeted offer model based on the success data (e.g., representative of a conversion rate associated with the initial targeted offers).

According to an embodiment, the communication component 116 can transmit the updated targeted offer model to a server (e.g., server 120). In this regard, transmitting the updated targeted offer model does not transmit the web browsing data (e.g., unless specifically authorized by a user or entity associated with the web browsing data). It can be appreciated that the communication component 116 can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.) The system 102 and/or various respective components can additionally comprise various graphical user interfaces (GUIs), input devices, or other suitable components.

In an embodiment, the communication component 116 can receive from the server (e.g., server 120), an updated base targeted offer model. In this regard, the updated base targeted offer model can be generated using federated machine learning (e.g., using an M.L. component 122 of the server 120) applied to the updated targeted offer model (e.g., from the system 102) and other updated targeted offer models, other than the updated targeted offer model, associated with other web browser applications (e.g., and corresponding systems) other than the web browser application (e.g., and corresponding system 102). In various embodiments, the web browsing history and/or the updated targeted offer model can be stored in a local data cache associated with a web browser extension of the web browser application (e.g., in a cache of a memory 104).

According to an embodiment, the communication component 116 can access, via a server (e.g., server 120), offer data representative of available offers. In this regard, the targeted offer can be further generated (e.g., by the targeted offer component 112) based on the available offers. For example, the server 120 can comprise a list or database of available offers that can be provided to one or more systems herein. In this regard, entities can be registered with the server 120 and/or system 102 in order to make offers (e.g., and ultimately targeted offers) available to the system 102 and/or other systems described herein.

According to an embodiment, the device status component 118 can determine battery status information representative of a battery status of user equipment associated with the web browser application. Such battery status information can comprise, for instance, a charge status of a device (e.g., a device comprising a system 102) or whether such a device is plugged in or operating on battery. In a further embodiment, the device status component 118 can determine network status information representative of a network connection type and strength of user equipment associated with the web browser application. Such network status information can comprise, for instance, a Wi-Fi connection or a cellular-based connection which in some examples, can draw more power than a Wi-Fi connection. In this regard, the M.L. component 114 can generate the updated targeted offer response to the battery status information being determined to satisfy a battery status threshold and/or the network status information being determined to satisfy a network status threshold. For instance, such a battery status threshold can be satisfied by a device being plugged-in or charged above a threshold charge percentage. Further, such a network status threshold can comprise a device utilizing a specific connection type (e.g., a Wi-Fi connection) or a threshold connection or signal strength to a network.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or M.L. components (e.g., M.L. component 114 and/or M.L. component 122) herein can comprise artificial intelligence component(s) which can employ an artificial intelligence (AI) model and/or M.L. or an M.L. model that can learn to perform the above or below described functions (e.g., via training using historical training data and/or feedback data).

In some embodiments, M.L. component 114 and/or M.L. component 122 can comprise an A.I. and/or M.L. model that can be trained (e.g., via supervised and/or unsupervised techniques) to perform the above or below-described functions using historical training data comprising various context conditions that correspond to various management operations. In this example, such an A.I. and/or M.L. model can further learn (e.g., via supervised and/or unsupervised techniques) to perform the above or below-described functions using training data comprising feedback data, where such feedback data can be collected and/or stored (e.g., in memory) by an M.L. component 114 and/or M.L. component 122. In this example, such feedback data can comprise the various instructions described above/below that can be input, for instance, to a system herein, over time in response to observed/stored context-based information.

A.I./M.L. components herein can initiate an operation(s) associated with a based on a defined level of confidence determined using information (e.g., feedback data). For example, based on learning to perform such functions described above using feedback data, performance information, and/or past performance information herein, an M.L. component 114 and/or M.L. component 122 herein can initiate an operation associated with federated machine learning (e.g., with a web browser extension). In another example, based on learning to perform such functions described above using feedback data, an M.L. component 114 and/or M.L. component 122 herein can initiate an operation associated with updating a model (e.g., a tuning model herein).

In an embodiment, the M.L. component 114 and/or M.L. component 122 can perform a utility-based analysis that factors cost of initiating the above-described operations versus benefit. In this embodiment, an artificial intelligence component can use one or more additional context conditions to determine an appropriate distance threshold or context information, or to determine an update for a tuning model.

To facilitate the above-described functions, an M.L. component herein can perform classifications, correlations, inferences, and/or expressions associated with principles of artificial intelligence. For instance, an M.L. component 114 and/or M.L. component 122 can employ an automatic classification system and/or an automatic classification. In one example, the M.L. component 114 and/or M.L. component 122 can employ a probabilistic and/or statistical-based analysis (e.g., factoring into the analysis utilities and costs) to learn and/or generate inferences. The M.L. component 114 and/or M.L. component 122 can employ any suitable machine-learning based techniques, statistical-based techniques and/or probabilistic-based techniques. For example, the M.L. component 114 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the M.L. component 114 and/or M.L. component 122 can perform a set of machine-learning computations. For instance, the M.L. component 114 and/or M.L. component 122 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

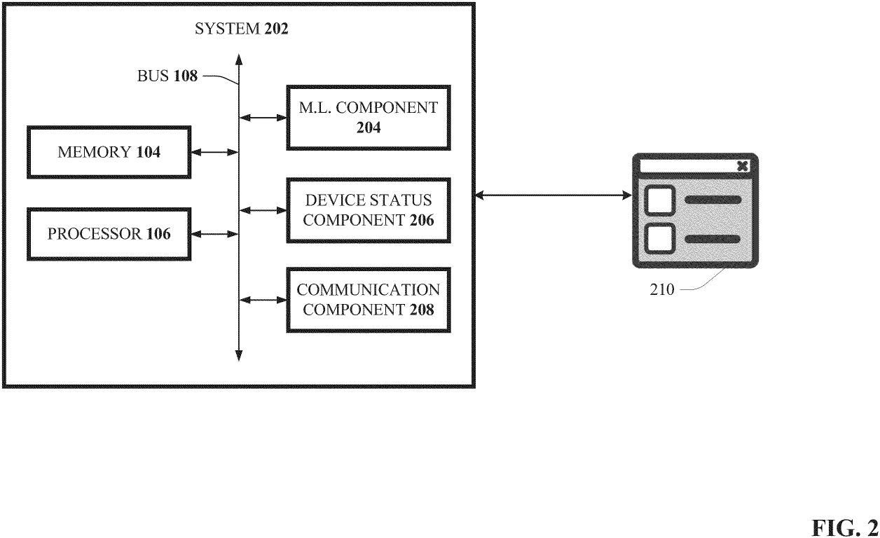

Turning now to FIG. 2, there is illustrated an example, non-limiting system 202 in accordance with one or more embodiments herein. System 202 can comprise a computerized tool, which can be configured to perform various operations relating to federated machine learning and/or web browser extensions. In one or more embodiments, the server 120 can comprise the system 202. The system 202 comprise one or more of a variety of components, such as memory 104, processor 106, bus 108, M.L. component 204, device status component 206, and/or communication component 208. In various embodiments, the system 202 can be communicatively coupled to a system 210 which, according to an embodiment, can be similar to the system 102. In this regard, a system 102 herein can be communicatively coupled to a system 202 herein. For example, system 102 and system 202 can comprise respective components in a private federated machine learning network employable to generate targeted offers herein.

It is noted that the M.L. component 204 can be similar to the M.L. component 114 and/or M.L. component 122, the device status component 206 can be similar to the device status component 118, and the communication component 208 can be similar to the communication component 116. In this regard, like descriptions are omitted for sake of brevity.

In various embodiments, one or more of the memory 104, processor 106, bus 108, M.L. component 204, device status component 206, and/or communication component 208 can be communicatively or operably coupled (e.g., over a bus or wireless network) to one another to perform one or more functions of the system 202.

According to an embodiment, the communication component 208 can send, to a web browser extension (e.g., a web browser extension enabled via the system 210 or system 102), a base targeted offer model. In this regard, the base targeted offer model can be generated based on federated machine learning (e.g., using the M.L. component 204) applied to past web browsing data representative of past web browsing history associated with other web browser extensions other than the web browser extension. According to an embodiment, past web browsing data (e.g., of other entities or users) can be utilized in order to generate the base targeted offer model. In this regard, the base targeted model can be served from within the browser extension in order to generate targeted offers based on browsing behavior (e.g., browsing history) using the base targeted offer model. According to an example, web browsing data can indicate that a web browser navigated to a “website A” associated with “store A” and/or “website B” associated with “store B.” Such web browsing data can be utilized by the base targeted offer model (and/or other models herein) in order to determine targeted offers (e.g., from available targeted offers) that a user would be likely to utilize to complete a purchase or transaction. Such a purchase or transaction can comprise a successful conversion of a targeted offer. In other embodiments a base targeted model can comprise a random initial model.

According to an embodiment, the communication component 208 can receive, from the web browser extension, an updated targeted offer model. In this regard, the updated targeted offer model is generated by the web browser extension (e.g., via a system 210 or system 102) based on success data representative of a level of success of the base targeted offer model according to a success criterion (e.g., a defined offer conversion rate), and based on the base targeted offer model. It is noted that in various embodiments, the updated targeted offer model does not include web browsing history associated with the web browser extension. The foregoing can comprise model training which can be utilized in order to improve accuracies models herein and/or conversion rates of targeted offers herein.

According to an embodiment, the M.L. component 204 can aggregate (e.g., using the federated machine learning) the updated targeted offer model with other updated targeted offer models, other than the updated targeted offer model, associated with other web browser extensions other than the web browser extension, resulting in an aggregated base targeted offer model. In one or more embodiments, the aggregation can comprise an average of one or more of the updated targeted offer model and other updated targeted offer models along with a base model. It is noted that such training can be repeated. For instance, models can be sent to/from web browser applications and central servers herein in order to continuously improve models (e.g., targeted offer models) without any web browsing data or other local data (e.g., other than model updates) being sent to the central server (e.g., the server 120). It is noted, however, that user data (e.g., browsing history) can be sent to the server (e.g., the server 120) if a user authorizes such collection and/or transfer of user data.

According to an embodiment, the communication component 208 can send the aggregated base targeted offer model to the web browser extension (e.g., via the system 210 and/or system 102) and to the other web browser extensions. In this regard, each of the web browser extension can receive the aggregated base targeted offer model, which can comprise an increases overall success and/or conversion rate than prior respective targeted offer models utilized by browser extensions and associated systems herein.

According to an embodiment, the device status component 206 can determine battery status information representative of a battery status of user equipment associated with the web browser application. Such battery status information can comprise, for instance, a charge status of a device (e.g., a device comprising a system 102) or whether such a device is plugged in or operating on battery. In a further embodiment, the device status component 206 can determine network status information representative of a network connection type and strength of user equipment associated with the web browser application. Such network status information can comprise, for instance, a Wi-Fi connection or a cellular-based connection which in some examples, can draw more power than a Wi-Fi connection. In this regard, the M.L. component 204 can generate the updated targeted offer response to the battery status information being determined to satisfy a battery status threshold and/or the network status information being determined to satisfy a network status threshold. For instance, such a battery status threshold can be satisfied by a device being plugged-in or charged above a threshold charge percentage. Further, such a network status threshold can comprise a device utilizing a specific connection type (e.g., a Wi-Fi connection) or a threshold connection or signal strength to a network.

According to an embodiment, the communication component 208 can send offer data representative of available offers. In this regard, the web browser extension can be enabled to generate a targeted offer from among the available offers based on web browsing history associated with the web browser extension and the base targeted offer model. It is noted that such model training (e.g., conducted by the system 210 or system 102) can be performed by utilizing the available offers and determining corresponding successes and failures associated with the presentations of the targeted offers to entities and/or users herein.

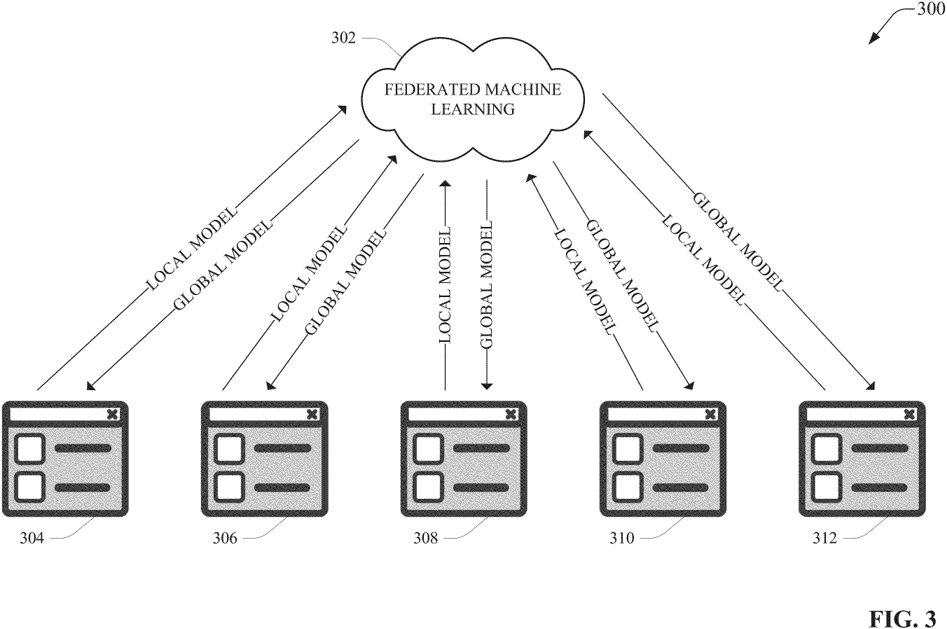

FIG. 3 illustrates a block diagram 300 of exemplary federated machine learning for use with a browser extension in accordance with one or more embodiments described herein. According to an embodiment, federated machine learning as utilized herein can comprise centralized federated learning, in which a server (e.g., federated machine learning server 302, server 120, and/or system 202) can be utilized in order to orchestrate and/or coordinate the participating web browser extension applications (e.g., browser extension 304, browser extension 306, browser extension 308, browser extension 310, browser extension 312, and/or other browser extensions and associated systems) during the federated machine learning (e.g., training) process. In other embodiments, decentralized federated learning can be utilized in which the browser extensions (e.g., via systems herein such as the system 102 or system 210) can coordinate between one another in order to generate a global model (e.g., a base targeted offer model). In various embodiments, the web browser extension applications can receive the global model from the server. In this regard, the global model can comprise or begin with a base model provided to the browser extension applications by the server. The browser extension applications can then perform machine learning training, starting with the base model (e.g., the base targeted offer model). One or more of the browser extension applications can then improve the model based on, for instance, success data (e.g., conversion rates) representative of a level of success of the base targeted offer model experienced at each respective browser extension application. Each of the changes made to the base model, by each respective browser extension application, can be provided to the server (e.g., in the form of one or more updated targeted offer models). It is noted that only the models and/or updates to the models are provided to the server. In this regard, actual browsing data (e.g., web browsing history) determined or observed by each respective browser extension application is not provided to the server. Further, updates to a base model herein, by the browser extension applications, can be encrypted to further increase data privacy. The server can then utilize the base model (e.g., base targeted offer model) and one or more updates from one or more browser extension applications (e.g., in the form of one or more updated targeted offer models) to generate an updated base model, in which the updated base model can comprise an aggregate of the original base model and the various updates from the various browser extension applications. Once the updated base targeted model has been generated (e.g., comprising an improved model over the original base model), the updated base model can be sent to each of the browser extension applications. In this regard, further training can be performed at each of the browser extension applications and the process can repeat, thus further refining such targeted offer models herein with each iteration.

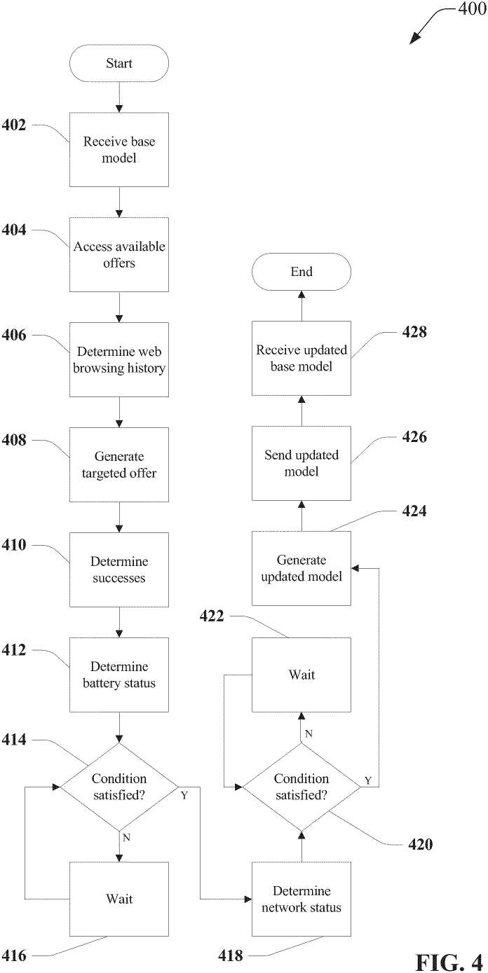

Turning now to FIG. 4, there is illustrated a flowchart of a process 400 associated with federated machine learning based browser extensions in accordance with one or more embodiments herein. All operations and/or any portion thereof described with respect to the figures herein may be performed by any suitable computer system, including system 102 and/or system 210, according to various embodiments. At 402, a browser extension application (e.g., utilizing a system 102 or system 210) can receive a base federated machine learning model (e.g., via communication component 116). At 404, available offers can be accessed or received (e.g., via the communication component 116) from a server (e.g., server 120 or system 202). At 406, web browsing data that are representative of web browsing history based on activity associated with a web browser application can be determined (e.g., using a browsing history component 110). At 408, a targeted offer can be generated (e.g., using a targeted offer component 112), for instance, using a base targeted offer model and based on the web browsing data. It is noted that the base targeted offer model can be generated based on federated machine learning (e.g., using an M.L. component 114 and/or M.L. component 122) applied to past web browsing data representative of past web browsing history associated with other web browser applications other than the web browser application. At 410, success data representative of a level of success of the base targeted offer model (e.g., according to a success criterion) can be determined (e.g., using the M.L. component 114). In various embodiments, the success data can be representative of a conversion rate associated with the initial targeted offers. At 412, battery status information representative of a battery status (e.g., charge status or power status) of user equipment associated with the web browser application can be determined (e.g., by a device status component 118). At 414, the battery status information can be compared to a battery status threshold. If the battery status information satisfies the threshold, the process 400 can proceed to 418. Otherwise, the process 400 can wait at 416 for a defined period of time or until the battery threshold is satisfied. At 418, network status information representative of a network type (e.g., Wi-Fi or cellular) and strength (e.g., connection or signal strength to a network) of user equipment associated with the web browser application can be determined (e.g., by a device status component 118). At 420, the network status information can be compared to a network status threshold. If the network status information satisfies the threshold, the process 400 can proceed to 424. Otherwise, the process 400 can wait at 422 for a defined period of time or until the network threshold is satisfied. At 424, an updated model can be generated by the M.L. component 114 (e.g., based on success data representative of a level of success, such as a conversion rate, of the base targeted offer model and based on the base targeted offer model).

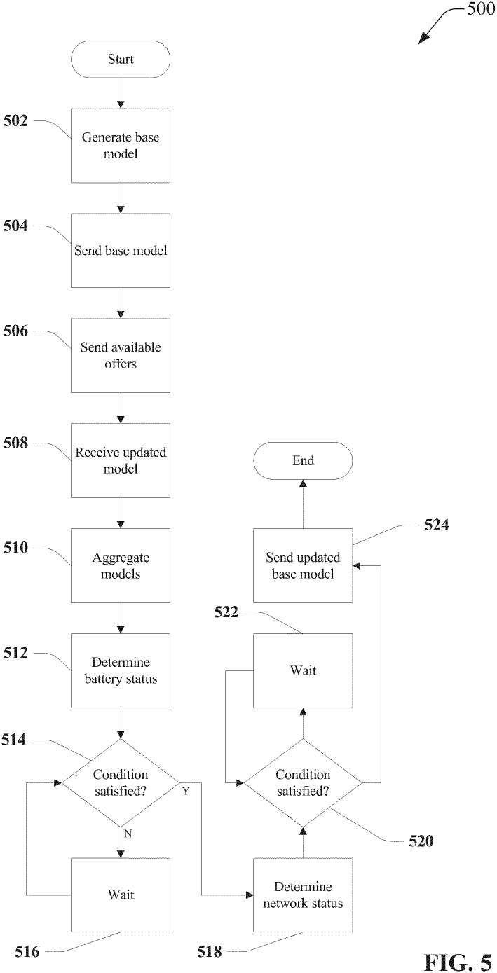

Turning now to FIG. 5, there is illustrated a flowchart of a process 500 associated with federated machine learning based browser extensions in accordance with one or more embodiments herein. At 502, a system (e.g., system 202 or server 120) can generate a base model. In some embodiments, the base model can comprise a random initial model. In other embodiments, the base model can be based on a prior model or based on a model generated via a browser extension application herein. For instance, the base targeted offer model can be generated based on federated machine learning (e.g., using the M.L. component 204) applied to past web browsing data representative of past web browsing history associated with other web browser extensions. At 504, the base model can be sent to one or more browser extension applications (e.g., using the communication component 208). At 506, available offers can be sent to the one or more browser extension applications (e.g., using the communication component 208). It is noted that the browser extension applications can utilize the base model and generate respective updated models, which can be received at 508 (e.g., via the communication component 208). It is noted that the updated targeted offer model(s) can be generated by the web browser extension(s) based on success data representative of a level of success of the base targeted offer model according to a success criterion, and based on the base targeted offer model. At 510, the updated targeted offer model can be aggregated with other updated targeted offer models, resulting in an aggregated base targeted offer model (e.g., using the M.L. component 204). At 512, battery status information representative of a battery status of user equipment associated with the web browser application can be determined (e.g., by a device status component 206). At 514, the battery status information can be compared to a battery status threshold (e.g., using the device status component 206). If the battery status information satisfies the threshold, the process 500 can proceed to 518. Otherwise, the process 500 can wait at 516 for a defined period of time or until the battery threshold is satisfied. At 518, network status information representative of a network type and strength of user equipment associated with the web browser application can be determined (e.g., by a device status component 206). At 520, the network status information can be compared to a network status threshold (e.g., using the device status component 206). If the network status information satisfies the threshold, the process 500 can proceed to 524. Otherwise, the process 500 can wait at 522 for a defined period of time or until the network threshold is satisfied. At 524, the aggregated base targeted offer model can be sent to the web browser extension(s) (e.g., via the communication component 208).

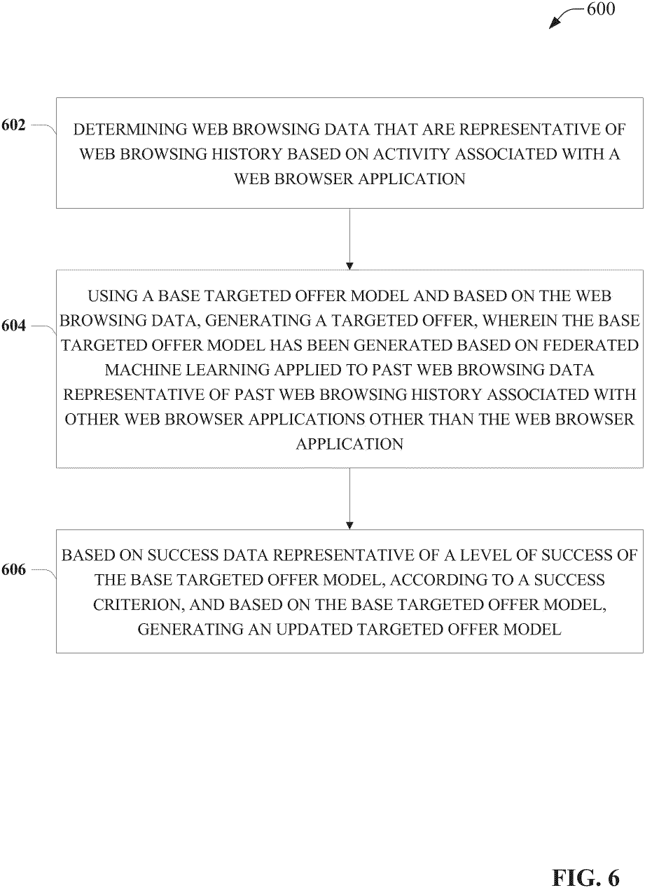

FIG. 6 illustrates a block flow diagram for a process 600 associated with federated machine learning based browser extensions in accordance with one or more embodiments described herein. At 602, the process 600 can comprise determining (e.g., using the browsing history component 110) web browsing data that are representative of web browsing history based on activity associated with a web browser application. At 604, the process 600 can comprise using a base targeted offer model and based on the web browsing data, generating a targeted offer (e.g., using the targeted offer component 112), wherein the base targeted offer model has been generated (e.g., using the M.L. component 114) based on federated machine learning applied to past web browsing data representative of past web browsing history associated with other web browser applications other than the web browser application. At 606, the process 600 can comprise based on success data representative of a level of success of the base targeted offer model, according to a success criterion, and based on the base targeted offer model, generating (e.g., using the M.L. component 114) an updated targeted offer model.

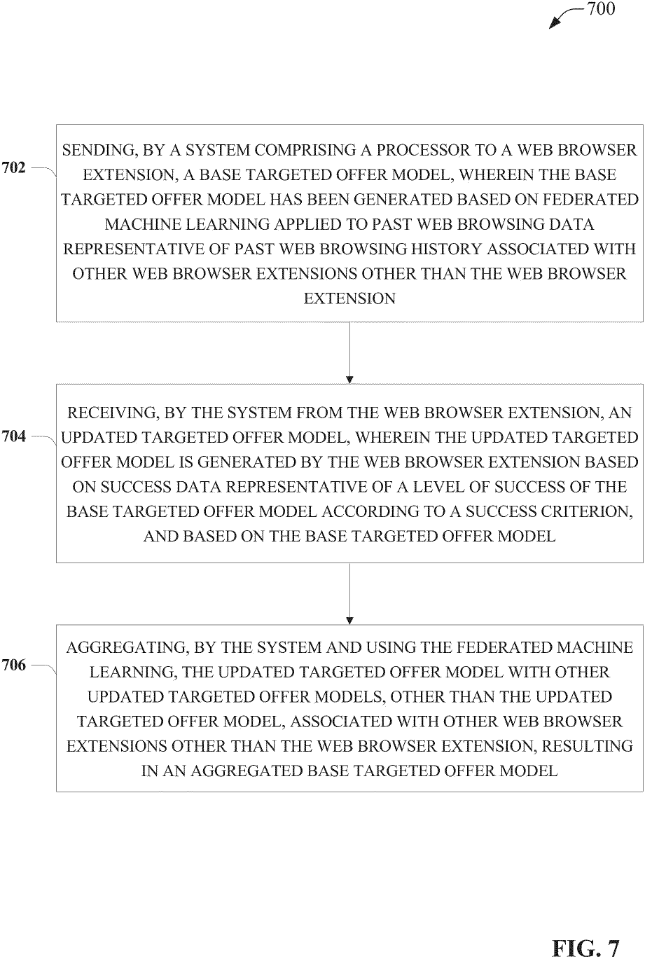

FIG. 7 illustrates a block flow diagram for a process 700 associated with federated machine learning based browser extensions in accordance with one or more embodiments described herein. At 702, the process 700 can comprise sending, by a system comprising a processor to a web browser extension (e.g., using a communication component 208), a base targeted offer model, wherein the base targeted offer model has been generated (e.g., using an M.L. component 204) based on federated machine learning applied to past web browsing data representative of past web browsing history associated with other web browser extensions other than the web browser extension. At 704, the process 700 can comprise receiving, by the system from the web browser extension (e.g., via the communication component 208), an updated targeted offer model, wherein the updated targeted offer model is generated (e.g., using the M.L. component 204) by the web browser extension based on success data representative of a level of success of the base targeted offer model according to a success criterion, and based on the base targeted offer model. At 706, the process 700 can comprise aggregating, by the system and using the federated machine learning (e.g., using the M.L. component 204), the updated targeted offer model with other updated targeted offer models, other than the updated targeted offer model, associated with other web browser extensions other than the web browser extension, resulting in an aggregated base targeted offer model.

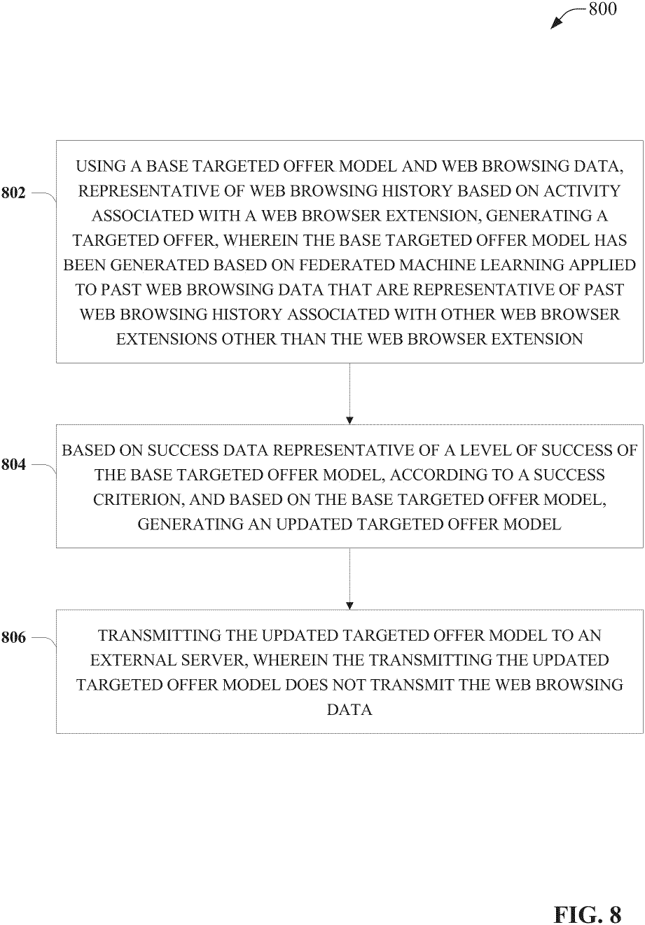

FIG. 8 illustrates a block flow diagram for a process 800 associated with federated machine learning based browser extensions in accordance with one or more embodiments described herein. At 802, the process 800 can comprise using a base targeted offer model and web browsing data (e.g., determined using the browsing history component 110), representative of web browsing history based on activity associated with a web browser extension, generating (e.g., targeted offer component 112) a targeted offer, wherein the base targeted offer model has been generated based on federated machine learning (e.g., using the M.L. component 114) applied to past web browsing data that are representative of past web browsing history associated with other web browser extensions other than the web browser extension. At 804, the process 800 can comprise based on success data representative of a level of success of the base targeted offer model, according to a success criterion, and based on the base targeted offer model, generating an updated targeted offer model (e.g., using the M.L. component 114). At 806, the process 800 can comprise transmitting (e.g., using the communication component 116) the updated targeted offer model to an external server, wherein the transmitting the updated targeted offer model does not transmit the web browsing data.

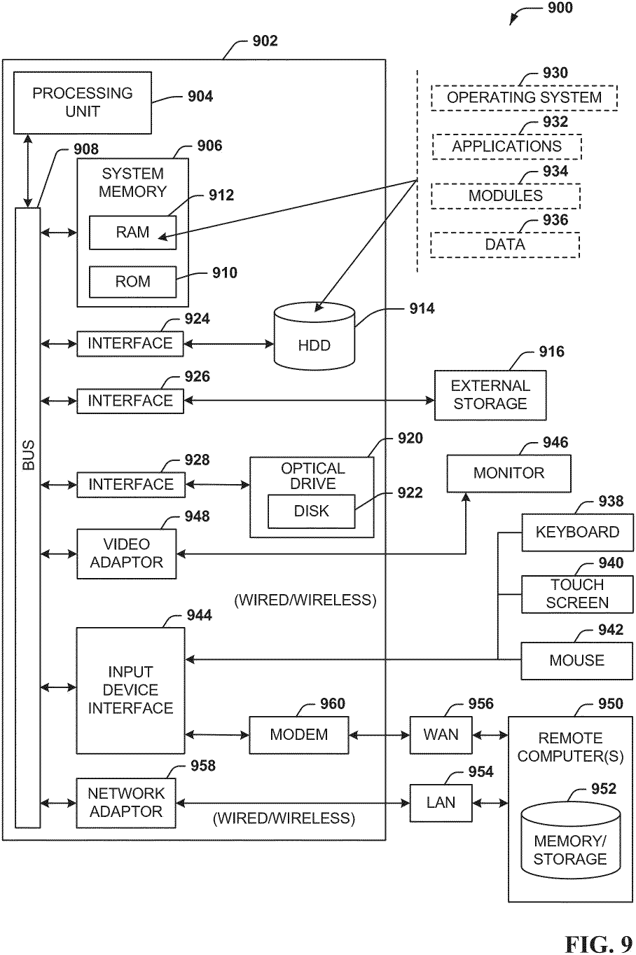

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enable with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTHⓇ wireless technologies. Thus, the communication can be a predefined structure as with a conventional network or simply an ad hoc communication between at least two devices.

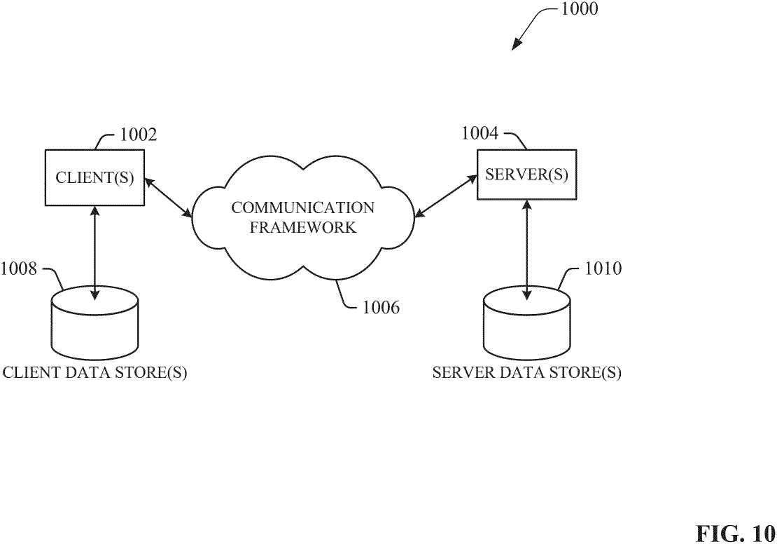

Referring now to FIG. 10, there is illustrated a schematic block diagram of a computing environment 1000 in accordance with this specification. The system 1000 includes one or more client(s) 1002, (e.g., computers, smart phones, tablets, cameras, PDA’s). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed file to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive - in a manner similar to the term “comprising” as an open transition word - without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A system, comprising:
a processor; and
a memory that stores executable instructions that, when executed by the processor, cause the system to perform operations, comprising:
determining web browsing data that are representative of web browsing history based on activity associated with a web browser application;
using a base targeted offer model and based on the web browsing data, generating a targeted offer, wherein the base targeted offer model has been generated based on federated machine learning applied to past web browsing data representative of past web browsing history associated with other web browser applications other than the web browser application; and
based on success data representative of a level of success of the base targeted offer model, according to a success criterion, and based on the base targeted offer model, generating an updated targeted offer model.

2. The system of claim 1, wherein the base targeted offer model is generated using the federated machine learning using respective machine learning operations at respective web browser applications, comprising the web browser application, without exchanging web browsing history between the web browser applications, and wherein the base targeted offer model generates initial targeted offers via the web browser application, based on the web browsing history.

3. The system of claim 2, wherein the web browsing history comprises past web browsing activity, accessed via the web browser application and associated with a product or service, and wherein an initial targeted offer of the initial targeted offers is based in part on the product or the service.

4. The system of claim 3, wherein the federated machine learning is employable, by the system, to generate the updated targeted offer model based on the success data, and wherein the success data is further representative of a conversion rate associated with the initial targeted offers.

5. The system of claim 1, wherein the operations further comprise:
transmitting the updated targeted offer model to a server, wherein the transmitting the updated targeted offer model does not transmit the web browsing data.

6. The system of claim 5, wherein the operations further comprise:
receiving, from the server, an updated base targeted offer model, wherein the updated base targeted offer model is generated using federated machine learning applied to the updated targeted offer model and other updated targeted offer models, other than the updated targeted offer model, associated with other web browser applications other than the web browser application.

7. The system of claim 1, wherein the web browsing history comprises historical web browsing activity associated with one or more users of the system, and wherein the web browsing history is employable, by the system using the base targeted offer model or the updated targeted offer model, to generate a targeted offer for a product or service.

8. The system of claim 1, wherein the web browsing history and the updated targeted offer model are stored in a local data cache associated with a web browser extension of the web browser application.

9. The system of claim 1, wherein the operations further comprise:
accessing, via a server, offer data representative of available offers, wherein the targeted offer is further generated based on the available offers.

10. The system of claim 1, wherein the operations further comprise:
determining battery status information representative of a battery status of user equipment associated with the web browser application, wherein the generating the updated targeted offer model comprises generating the updated targeted offer model in response to the battery status information being determined to satisfy a battery status threshold.

11. The system of claim 1, wherein the operations further comprise:
determining network status information representative of a network connection type and strength of user equipment associated with the web browser application, wherein the generating the updated targeted offer model comprises generating the updated targeted offer model in response to the network status information being determined to satisfy a network status threshold.

12. A computer-implemented method, comprising:
sending, by a system comprising a processor to a web browser extension, a base targeted offer model, wherein the base targeted offer model has been generated based on federated machine learning applied to past web browsing data representative of past web browsing history associated with other web browser extensions other than the web browser extension;
receiving, by the system from the web browser extension, an updated targeted offer model, wherein the updated targeted offer model is generated by the web browser extension based on success data representative of a level of success of the base targeted offer model according to a success criterion, and based on the base targeted offer model; and
aggregating, by the system and using the federated machine learning, the updated targeted offer model with other updated targeted offer models, other than the updated targeted offer model, associated with other web browser extensions other than the web browser extension, resulting in an aggregated base targeted offer model.

13. The computer-implemented method of claim 12, further comprising:
sending, by the system, the aggregated base targeted offer model to the web browser extension and to the other web browser extensions.

14. The computer-implemented method of claim 13, further comprising:
determining, by the system, battery status information representative of a battery status of user equipment associated with the web browser extension, wherein the sending the aggregated base targeted offer model to the web browser extension comprises sending the aggregated base targeted offer model to the web browser extension in response to the battery status information being determined to satisfy a battery status threshold.

15. The computer-implemented method of claim 13, further comprising:
determining, by the system, network status information representative of a network connection type and strength of user equipment associated with the web browser extension, wherein the sending the aggregated base targeted offer model to the web browser extension comprises sending the aggregated base targeted offer model to the web browser extension in response to the network status information being determined to satisfy a network status threshold.

16. The computer-implemented method of claim 12, wherein the updated targeted offer model does not include web browsing history associated with the web browser extension.

17. The computer-implemented method of claim 12, further comprising:
sending, by the system to the web browser extension, offer data representative of available offers, wherein the web browser extension generates a targeted offer from among the available offers based on web browsing history associated with the web browser extension and the base targeted offer model.

18. A non-transitory machine-readable medium, comprising executable instructions that, when executed by a processor, facilitate performance of operations, comprising:
using a base targeted offer model and web browsing data, representative of web browsing history based on activity associated with a web browser extension, generating a targeted offer, wherein the base targeted offer model has been generated based on federated machine learning applied to past web browsing data that are representative of past web browsing history associated with other web browser extensions other than the web browser extension;
based on success data representative of a level of success of the base targeted offer model, according to a success criterion, and based on the base targeted offer model, generating an updated targeted offer model; and
transmitting the updated targeted offer model to an external server, wherein the transmitting the updated targeted offer model does not transmit the web browsing data.

19. The non-transitory machine-readable medium of claim 18, wherein the operations further comprise:
receiving, from the external server, an updated base targeted offer model, wherein the updated base targeted offer model is generated using federated machine learning applied to the updated targeted offer model and other updated targeted offer models, other than the updated targeted offer model, associated with other web browser extensions other than the web browser extension.

20. The non-transitory machine-readable medium of claim 18, wherein the operations further comprise:
accessing, from the external server, offer data representative of available offers, wherein the targeted offer is from among the available offers.
